(19) United States
(12) Patent Application Publication
(10) Pub. No.: US 2008/0041836 A1
(43) Pub. Date: Feb. 21, 2008

(54) High temperature heating element for preventing contamination of a work piece

(76) Inventor: Nicholas Gralenski, Aptos, CA (US)

Correspondence Address: WOODSIDE IP GROUP, P.O. BOX 61047, PALO ALTO, CA, 94306, US

(21) Appl. No.: 11/893,254

(22) Filed: Aug. 14, 2007

Related U.S. Application Data
(63) Continuation-in-part of application No. 10/772,188, filed on Feb. 3, 2004.

(51) Int. Cl. H05B 1/00

(52) U.S. Cl. 219/156

(57) ABSTRACT

A modular heating element that facilitates removal and replacement without disassembly of a furnace provides a precisely controllable process temperature in the range 1000-1400 degrees centigrade. The configuration of the heating element is linear rather than coiled, and the temperature is monitored directly by measuring the electrical resistance of KANTHAL®, or other like Fe Cr Al wire encased in an aluminum ceramic sleeve that provides mechanical support and seals the heating element wire against oxidation, thereby increasing operational temperature and prolonging service life.

### CROSS-REFERENCE TO RELATED APPLICATION

This patent application is a continuation in part of U.S. Ser. No. 10/772,188, filed Feb. 3, 2004.

### BACKGROUND

1. Field of the Invention

The field of the invention generally relates to heating apparatus. In particular, the field of the invention relates to a heating element for providing contamination free processing of a substrate or workpiece at elevated temperatures, wherein temperature differences between the heating element and a substrate or workpiece are minimized. The heating element has a modular, feed-through configuration that enables it to be inserted directly into a process chamber from the exterior of a furnace for ease of removal and replacement.

1. Background of Related Art

The manufacture of semiconductor devices requires the deposition of thin dielectric films upon semiconductor wafers at high working temperatures. The most commonly used process is chemical vapor deposition (CVD), using precursors such as silane, disilane, tetraethyl orthosilicate and others for the formation of a variety of films on a semiconductor substrate. CVD processes supply reactive gases to the substrate surface where heat-induced chemical reactions take place at elevated temperatures to produce a desired thin film. Preparation of micro-circuitry on silicon wafer semiconductor substrates also requires high temperature CVD formation of conductive, insulative, optical and dopant source coatings for later formation of source/drain junctions.

At high temperatures, suitable structural materials for heating elements are limited. Even heating elements with high temperature structural capacity may be unable to withstand the oxidation or other chemical conditions imposed by high temperature CVD processes. Heating elements themselves thus become sources of contamination. Therefore, what is needed is a heating element suitable for a high temperature CVD process that is characterized by both structural integrity as well as oxidation and contamination free operation.

Evaporation and/or spalling of metal, such as from a heating element, can become a serious contamination factor in a conventional furnace for semiconductor processing, beginning at about 500° C. Such evaporation is a natural consequence of the vapor pressure of materials. Vapor pressure varies with materials and is about 100 billion times greater at 1200° C. than at 500° C. Thus, the potential for particulate contamination through out gassing, spalling, or oxidation of a heating element operating at high temperatures is a critical process limitation.

Increasingly stringent requirements for CVD processes are needed in order to produce quality thin film devices without impurities at reduced dimensions and at high production rates. It is desirable for improved quality and purity of thin film structures that produce source/drain junctions to achieve a process temperature of 1200° to 1300° C.; and even 1400° C. For a substrate to be heated to such temperature, the conventional heating element must be even hotter. This has resulted in the development of heating elements comprising materials capable of withstanding high temperatures, such as graphite, tungsten, molybdenum and others. However, such materials are expensive and difficult to use, requiring a disadvantageously high current power supply. Molybdenum in particular is subject to out gassing and may result in the processed substrates becoming coated with a thin molybdenum film, or the surface of the workpiece may react with molybdenum vapor. Therefore, what is needed is a heating element that can maintain structural integrity and operate reliably in long term exposure to such temperatures, while not becoming a source of contamination in the intended process.

As the need for thin film devices accelerates, so too does the need for a more efficient and economical furnace for device fabrication. Unfortunately, simultaneous improvement in device fabrication processes, device performance and cost, has been difficult to achieve due to a number of structural and functional limitations in conventional furnaces. Conventional heating elements employ wire coiling, to increase power density and to accommodate thermal expansion. However, conventional heating element coils are characterized by increased resistivity and are prone to oxidation at high temperatures. In a coil configuration it is difficult to maintain constant resistance at high temperatures. The resistance per linear inch varies as the coils expand and contract. The spacing between coils cannot be closely regulated at high temperatures, producing temperature variations and hot spots. When pushed to high operating temperature, hot spots in the coils frequently result in heating element failure. Furnaces employing conventional elements are often unsuitable for economical and high throughput thin film device fabrication, even at 500° C. process temperatures, let alone operating ranges at 1200° C. and above.

In an attempt to overcome high temperature spalling of particles and process contamination from heating elements, many conventional furnaces for CVD isolate or separate the process area and the substrate or product from the heat source. The process chamber is typically a horizontal tunnel (muffle) through which product (such as a silicon wafer) is carried on a wire mesh belt or conveyor. The heating elements are often placed outside the process chamber. Such remote location of the heating elements from the workpiece forces the heating elements to operate at a higher temperature to achieve a desired processing temperature. When heating elements are located outside the muffle, the heating elements may be operating at 1200° C. to heat the muffle to 750° C., which heats the conveyor belt to 650° C., which then heats the substrate to the desired temperature of 500° C.

Note that in such a conventional furnace, more time is required for heating and cooling, and a larger temperature difference, ΔT, between heat source and substrate is required to induce desired heating of the substrate. Traditional thermal insulation generally is used to minimize heat loss and smooth out temperature gradients. However, this disadvantageously forces the process chamber to operate at high temperature and causes a slow rate of heating and cooling (poor thermal response) when a temperature change is required.

Further, such a large ΔT between the substrate or product and heating elements located externally with respect to the process chamber means that the process chamber itself must act as a heat source hotter than the work. Accordingly, conventional process chamber materials are subject to heat damage, distortion, and may act as a source of contamination, thus resulting in time-consuming maintenance issues and slow processing rates.

It is therefore desirable to provide an improved, thermally efficient furnace for CVD processing, wherein the ΔT between the substrate and heating elements is minimized for enhanced process control and wherein heating elements are able to meet the higher thermal demands for forming ultra-shallow doped regions including, source/drain junctions without causing evaporative metal contamination.

### SUMMARY

In order to overcome the foregoing disadvantages of conventional heating elements for semiconductor processing systems, an aspect of the invention provides a heating element comprising an aluminum oxide (Al₂O₃) ceramic sheath for supporting and enclosing a graded Ohmic composite wire comprising a main heating portion consisting of a Fe Cr Al resistance heating alloy, such as KANTHAL®, or the like, a transition portion of nichrome, and a terminal portion comprising nickel for connection to a source of electric current. The term KANTHAL®, as used herein refers to any commonly known Fe Cr Al resistance heating alloy containing, apart from iron, approximate amounts of the following: chromium (20-30 percent), aluminum 4-7.5 percent and small amounts of cobalt.

In another aspect of the invention, a non-permeable aluminum oxide ceramic sheath has the effect of chemically isolating the Fe Cr Al resistance heating wire, thereby preventing the heating elements from becoming a source of contamination. Conversely, the aluminum oxide ceramic sheath also prevents process chamber gases or sputtered particles of the workpiece or substrate from contaminating or degrading the heating element wire.

The Fe Cr Al resistance heating element wire is provided in flush engagement in through holes defined in the aluminum oxide ceramic sheath. The flush engagement of the aluminum oxide ceramic against the Fe Cr Al wire, allows for differential thermal expansion of the wire, but does not chemically react with the wire.

The flush engagement between the heating element wire and the surrounding material of the aluminum oxide ceramic provides the following advantages. It effectively seals the Fe Cr Al portion of the heating element. That is, the aluminum ceramic sheath provides a chemically compatible enclosure that forms a protective shell, limiting the formation of the oxide layer on the KANTHAL® wire and protecting the workpiece or substrate from spalling of particles from the wire. Also, the flush engagement of the aluminum oxide ceramic restricts entry of oxygen into the interior of the through holes, such that no additional oxygen is available to react with the Fe Cr Al wire to increase the thickness of the oxide layer.

In a preferred embodiment, a plurality of heating elements is provided for modular, insertion into a furnace containing a process chamber. The ends of the ceramic portion of each heating element terminate in a plenum on either side of the process chamber, each plenum holding an inert gas. The inert gas further restricts the entry of oxygen to the heating element wire and strictly limits the thickness of an oxide layer able to form on the wire.

In another aspect of the invention, a plurality of heating elements are provided for modular insertion into a highly reflective enclosure or process chamber to increase energy efficiency and place the elements in close proximity with a substrate or work piece to minimize temperature differences (ΔT) between the heating elements and substrate. The heating elements are disposed preferably in parallel through opposite sidewalls of the highly reflective process chamber The modular configuration allows each heating element to be separately removed and replaced for repair or maintenance from outside the process chamber, leaving the process chamber intact.

In a further aspect of the invention, the heating elements are preferably supported in tangential, point contact on the bottom surface of through holes provided in opposite walls of a process chamber. The walls of a preferred highly reflective process chamber comprise polished aluminum and are provided with cooling channels for the circulation of a coolant such as water. The tangential point contact between the heating element and water-cooled aluminum wall provides a minimized surface to surface point of contact. While a significant ΔT exists between the heating element and the water-cooled aluminum wall, there is no melting or aluminum contamination as the thermal resistance provided by the minimized point of contact affords an enormous thermal gradient. This enables the heating element to operate at full temperature minimizing the ΔT with the workpiece or substrate. Differential thermal expansion of the element also can take place without structural change or distortions.

In accordance with another aspect of the invention, the Fe Cr Al resistance heating alloy, such as KANTHAL® can be provided in an essentially linear, double backed fashion through the aluminum ceramic sheath. This aspect of the invention advantageously overcomes the problems associated with traditional coiling of heating element wire, used to increase power density. The spacing of coils cannot be closely regulated and leads to temperature variations. When pushed to high operating temperature, hot spots in the coils lead to heating element failure.

The linear configuration of the heating element wire, coupled with the minimized ΔT with the substrate or workpiece, enables temperature of the heating elements and workpiece to be accurately determined and closely controlled, thereby providing a quick thermal response for faster processing and high throughput.

The foregoing aspects of the invention enable a KANTHAL® or other Fe Cr Al heating element to have a prolonged service life at a given temperature and to be used in higher temperature applications than was previously possible, up to about 1400° C. and above. The ΔT between heating elements and a work piece is minimized, such that the temperature of the workpiece can be closely controlled and is only slightly less than the temperature of the heating elements. Contamination cannot permeate through the aluminum ceramic sheath to degrade the heating element wire, and the heating element does not contaminate the workpiece.

### BRIEF DESCRIPTION OF THE DRAWINGS

The drawings are heuristic for clarity. The foregoing and other features, aspects and advantages of the invention will become better understood with regard to the following descriptions, appended claims and accompanying drawings in which:

FIG. 1A is a perspective drawing of a heating element in accordance with an aspect of the present invention.

FIG. 1B is an alternate perspective view of the heating element of FIG. 1A, absent the aluminum ceramic sheath.

FIG. 2 is an alternate, generalized embodiment of the heating element of FIG. 1A.

FIG. 3 is a sectional view of a heating element of FIG. 1A in accordance with an aspect of the invention.

FIG. 4 is a diagrammatic side view showing constituent sections of a heating element in accordance with an aspect of the present invention.

FIG. 5 is a diagrammatic side view showing the relation of constituent sections of the heating element of FIG. 4 with respect to the principal heating zone of a furnace.

FIG. 6 is a front sectional view of an example furnace and process chamber incorporating a plurality of heating elements as shown in FIG. 1A in accordance with an aspect of the present invention.

FIG. 7 is a perspective diagrammatic view of the furnace and process chamber of FIG. 6.

FIG. 8 is a side view of a distal end of a heating element showing the minimized tangential point of contact between the surface of a heating element and a supporting wall of the process chamber of FIGS. 6 and 7 in accordance with an aspect of the present invention.

### DETAILED DESCRIPTION

Overview

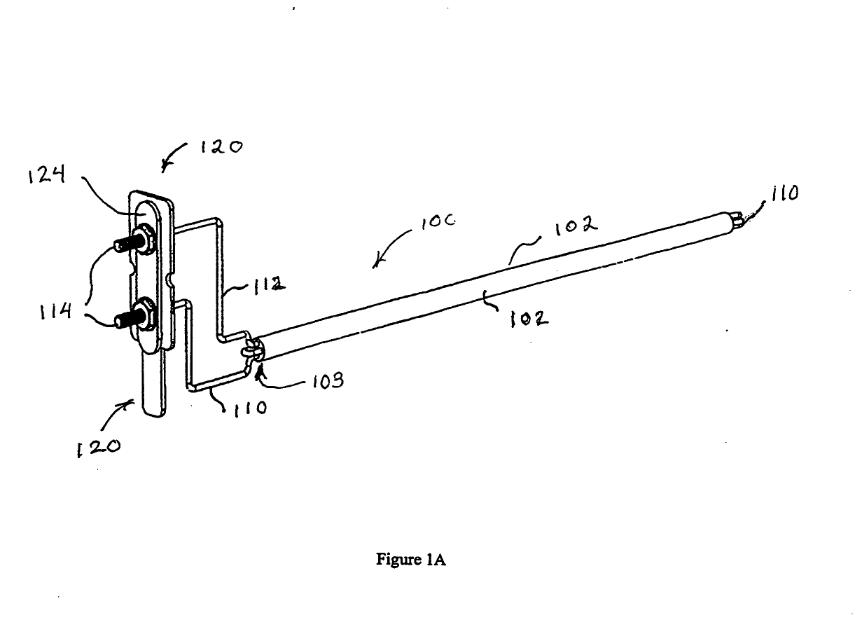

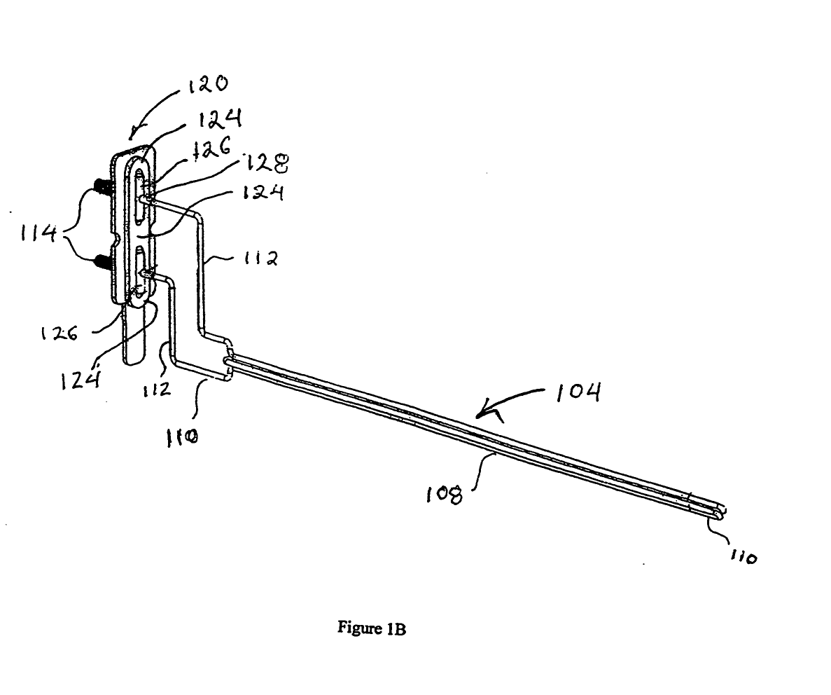

Referring to FIGS. 1A, and 1B, a heating element assembly 100 in accordance with an aspect of the invention comprises an aluminum oxide ceramic sleeve or sheath 102. Through holes or bores 103 are provided along the longitudinal axis of the ceramic sleeve 102 for protectively enclosing and supporting a heating element wire 104. The heating element wire 104 comprises a main heating portion 108 consisting of an iron chromium aluminum (Fe Cr Al) resistance heating alloy, such as KANTHAL®, a transition portion 110 comprising preferably nichrome, and a terminal portion or end 112 comprising nickel for connection to a source of electric current at power terminals 114. The KANTHAL®, or other resistive heating wire comprises main heating portion 108 having a first diameter for producing a maximum amount of heat within the ceramic sleeve or sheath 102. Optionally, the KANTHAL®, or other resistive heating wire does not need to be a constant diameter, but also may comprise a second portion having an appropriate diameter for interfacing with a transitional nichrome portion 110. In accordance with an aspect of the invention, nichrome portion 110 is provided at both ends of the ceramic sleeve 102 in tight, flush engagement with the interior surface of through-holes 103 and effectively prevent substantially all air from entering the through holes. The nichrome portion 110 provided in the entrance portions of through-holes 103 at both ends of the ceramic sleeve 102 effectively also seals the interior KANTHAL®, or similar Fe Cr Al, portion of the heating element against air, and thus strictly limits oxidation of the KANTHAL®, or like resistive heating element. The term KANTHAL®, as used herein refers to any commonly known Fe Cr Al resistance heating alloy containing, apart from iron, approximately: 20-30 percent chromium, 4-7.5 percent aluminum and small amounts of cobalt.

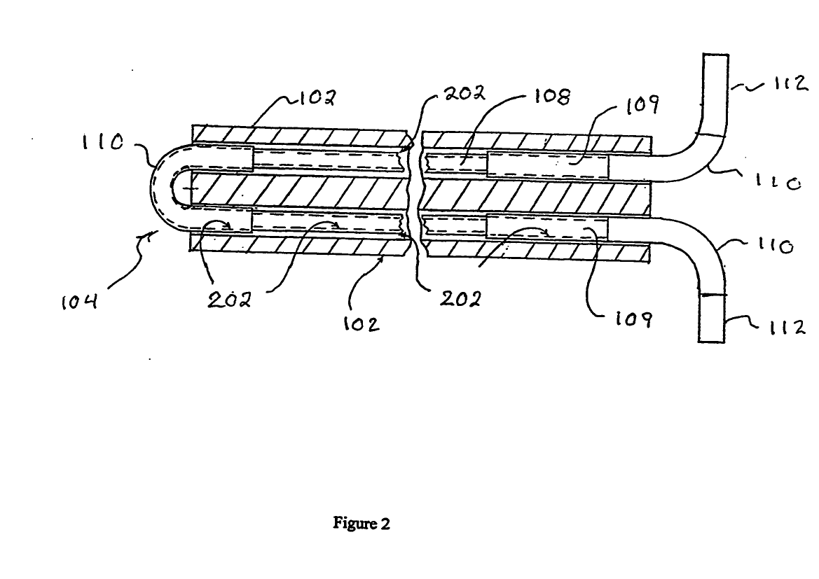

Referring to FIGS. 1B, 2 and 3, heating element wire 104 is also provided in substantially flush engagement within bores or through-holes 103 defined in aluminum ceramic sleeve 102. In the case where the ceramic sleeve 102 is provided with two through-holes 103 as shown in FIG. 2, the wire 104 is looped back in linear fashion so that terminal ends 112 are on the same end for attachment to a source of electric current. Thus, the heating element assembly 100 is simply plugged into a furnace as a modular cartridge.

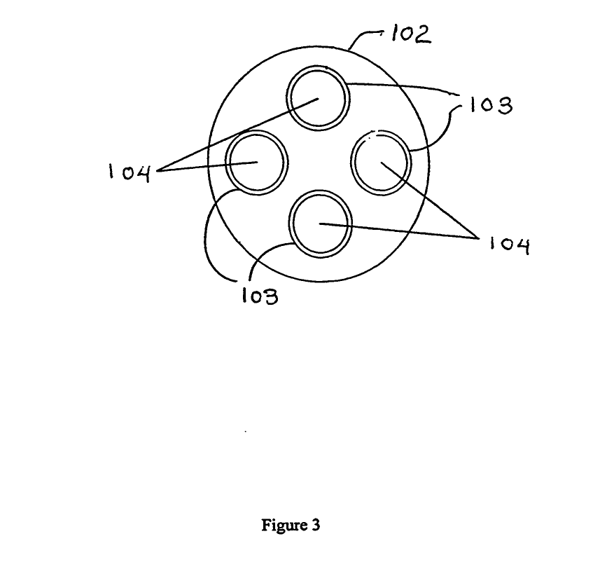

As shown in FIG. 2, doubling back the heating element wire 104 further has the advantage of doubling the amount of the heat source within the ceramic sleeve 102 (as opposed to a single wire) without the disadvantage of coiling. In the case where the aluminum ceramic sleeve 102 is round (which is preferred, because the typical access ports of a furnace for receiving heating assembly 100 are round), four through holes 103 are provided as shown in FIG. 3. Four through-holes make optimal use of the aluminum ceramic material available in sleeve 102. In that case, the heating element wire 104 is double backed twice, at each end of the ceramic sleeve 102 as shown in FIG. 1B to provide four separate resistance heating wires, one wire 104 in each through-hole as shown in FIG. 3. This preferred configuration doubles again (as compared to the configuration of FIG. 2) the amount of heat source within the ceramic sleeve 102 without the disadvantage of coiling. Although more than four holes could be used in accordance with this aspect of the invention, the increased manufacturing complexity and cost would be undesirable. Also, additional through-holes would result in excess wire crowding that would interfere with heat flow such that the resistance heating wires 104 would start to heat each other, rather than the workpiece, as is the case with a conventional coiling configuration.

The configuration of the heating element assembly 100 and wire 104 is substantially linear, providing a consistent relationship of watts per linear inch. This enables temperature to be determined directly by monitoring the electrical resistance of the KANTHAL®, or similar Fe Cr Al, portion within the ceramic sleeve. This tracks the temperature within the heating elements and thus provides an accurate, substantially instantaneous measurement of temperature within the heating element, without the time lag of a conventional thermocouple. Temperature control with active feedback may be provided by a microprocessor controller in accordance with means that are well known to those skilled in the art to ensure a quick thermal response when desired.

Referring to FIGS. 1A, 2 and 3, the service temperature of a KANTHAL®, or like Fe Cr Al resistive heating element can be increased up to 1400° C. by encasing the resistance heating element in the aluminum oxide (Al₂O₃) ceramic sheath. Fe Cr Al resistance heating alloys are used for high temperature applications due to an aluminum oxide protective layer that forms on the surface. However, in the course of normal operation continued growth of the oxide layer on the heating element wire at high temperatures destroys the underlying metal and increases Ohmic resistance, shortening the life of the heating element. The oxide layer also may become a serious source of contamination in a conventional Fe Cr Al heating element.

An aspect of the present invention comprises encasing the heating element wire 104 in an aluminum oxide ceramic sheath 102 comprising commercially available 99.8% alumina. While a number of ceramics may be compatible with a 1400° C. service temperature, if they are not strictly aluminum oxide (Al₂O₃), there is a risk that a lower melting eutectic will form between the heating element metal's oxide layer and the ceramic, also an oxide. For example, mullite, a high temperature crystalline compound of alumina and silica with the formula 3Al₂O₃2SiO₂ is nominally 60% alumina and 40% silica. Mullite has the risk of small inclusions that could destroy the thin protective oxide on the underlying heating element metal. Another ceramic, called alumina, is only 90-94% alumina, and thus has the same risk.

Therefore, aluminum oxide (Al₂O₃) is the preferred material for the ceramic sleeve enclosing the heating element wire. The melting point of KANTHAL®, is 1500° C., and in accordance with an aspect of the invention, the structure and composition of the heating element assembly 100 enable KANTHAL®, to attain a maximum practical service temperature of 1400° C. The expected service requirement is 1400° C. (to impart a workpiece or substrate temperature of 1200-1300° C.). At such temperatures, the mechanical strength of KANTHAL® or other Fe Cr Al resistance heating alloys is very weak and ordinarily would preclude their use as heating elements. Alumina ceramic (Al₂O₃), by comparison melts at 2050° C. and its mechanical strength at 1400° C. is excellent.

In air, Fe Cr Al resistance heating alloy, such as KANTHAL®, forms an outer layer of aluminum oxide. As long as this aluminum oxide layer is less than ˜100 Å, the bond strength between the aluminum oxide layer and the KANTHAL®, wire is greater than the shear strength through differential thermal expansion as the wire undergoes heating cycles. At high service temperature, the aluminum oxide coating of the Fe Cr Al resistance heating alloy wire becomes thicker. When the heating element cools, the difference in thermal expansion coefficient between the heating element metal and the aluminum oxide layer makes the oxide spall off. It must then re-form but at the expense of, and in deterioration of, the underlying metal of the heating element.

In order to overcome problems associated with oxide induced deterioration of conventional heating elements, the aluminum oxide ceramic sheath 102 effectively seals and chemically isolates the Fe Cr Al resistance heating wire 104, thereby limiting the thickness of an oxide layer and preventing the heating element from becoming a source of contamination. Conversely, the aluminum oxide ceramic sheath 104 also prevents process chamber gases or sputtered particles of the workpiece or substrate from contaminating or degrading the heating element wire.

Referring to FIGS. 2 and 3, the interior surface of bores or through holes 103 defined in aluminum oxide ceramic sheath 102 is provided in substantially flush engagement against the Fe Cr Al resistance heating element wire 104. The flush engagement allows for differential thermal expansion of the wire, but is sufficiently tight to prevent entry of air. Note that larger diameter nichrome portions 110 of heating element wire 104 extend from the outside into the entrance portions of through holes 103 to further seal the interior of ceramic sleeve 104 against air. Due to such substantially airtight engagement between the heating element wire and the surrounding material of the aluminum oxide ceramic, there is substantially no additional oxygen available to react with the KANTHAL®, or other Fe Cr Al wire and increase the thickness of the outer oxide layer.

Thus, encasing the KANTHAL®, or other Fe Cr Al resistance heating alloy wire 104 in aluminum ceramic sheath 102 prevents the formation of oxide at a given temperature and enables a Fe Cr Al resistance heating alloy wire to be used in higher temperature applications than was previously possible, up to 1400 degrees C. and above. A further advantage of this aspect of the invention is that the enclosing aluminum oxide sheath 102 is non-permeable. Thus, any contamination due to vapor pressure or spalling from the heating element wire 104 is sealed within the aluminum ceramic sheath 102. And, contamination outside the sheath 102 cannot permeate through to degrade the heating element wire 104.

Composition of the Heating Element

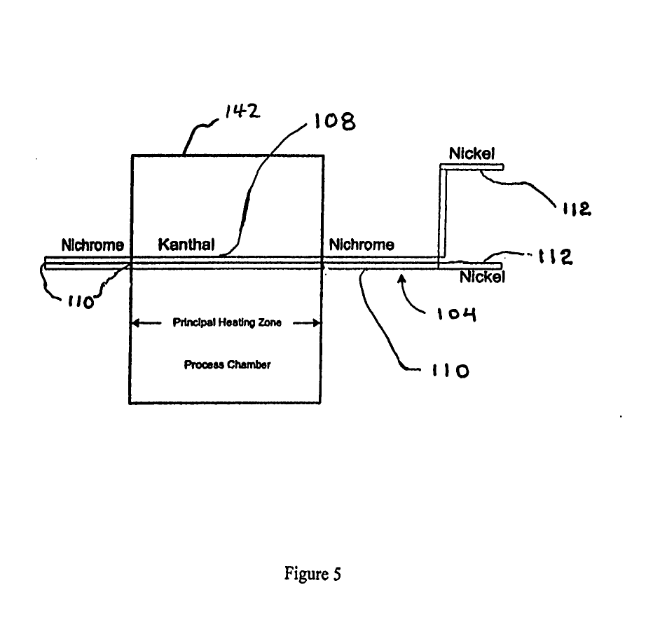

Referring to FIGS. 1B, 4 and 5, the heating element wire 104 provides a graduated Ohmic transition that concentrates the heating effect within a principal heating zone that encompasses the process chamber 142 and achieves a minimized ΔT between the heating element and workpiece or substrate in the process chamber. To avoid a long awkward structure, the present heating element wire 104 is a composite of metals that enable power terminals 114 to operate at efficiently at a modest temperature while concentrating the heat within the primary heating portion 108, and enabling sustained operation up to about 1400 degrees C.

The graduated Ohmic transition in the heating element wire 104 is as follows. At 20° C., KANTHAL® has a resistivity of 120 micro Ohms/cm. Nichrome has a resistivity of about 110 micro Ohms/cm. Nickel has a resistivity of 6.9 micro Ohms/cm. The wires are transitioned both according to their resistivity and their respective diameters such that the wide diameter/low resistivity Nickel is provided for a connection to a source of electric current for maximized conduction of current. Nichrome is provided as a transitional material for fusion bonding or welding to KANTHAL®, without creating undue brittleness in the KANTHAL®,

The primary heating portion or section 108 comprises KANTHAL®, or other like Fe Cr Al wire characterized by high resistance and high heat. This section is fusion bonded to virtually the same size or slightly larger diameter nichrome 110, or other similar metal wire characterized by lower resistance, and lower heat. As shown in FIG. 1B, the nichrome section 110 is very slightly smaller in diameter than the bores or through holes 103 defined in ceramic sleeve or sheath 102 to effectively seal the interior of the ceramic sleeve against entry of air. The nichrome section 110 is similarly bonded to nickel wire 112, characterized by much lower resistance, thus higher conductivity, and much lower heat. Nickel portion 112 is attached to terminals 114 for connection to a source of electric power. Terminals are provided at the same end of heating element 104 to facilitate ease of installation and servicing.

Fusion bonding of the separate portions of the wires allows the heating element wire to be inserted through the minimally sized through holes 103 in ceramic (Al₂O₃) sleeve 104 that provides necessary mechanical support for the wire at high temperatures, and which keeps multiple heating portions 108 separate and accurately indexed to optimize thermal geometry.

The foregoing aspects of the invention make KANTHAL®, or other like Fe Cr Al wire useful and cost effective to process temperatures up to 1400° C. In contrast, in conventional applications KANTHAL® shows limitations at temperatures even as low as 500° C.

Welding Techniques

The transitions between KANTHAL®, or other like Fe Cr Al wire, nichrome, and nickel are accomplished by conventional TIG or tungsten inert gas welding techniques that are performed carefully to avoid eutectic degradation. It has been found that welding of Nichrome to KANTHAL® can be accomplished without eutectic degradation by a short duration TIG welds on the order of 1/10 of a second or less. Short duration TIG welding appears to prevent exaggerated crystal growth in the KANTHAL® and prevents breaking or brittleness along grain boundaries. It may be possible to weld KANTHAL® to Nichrome by other equivalent techniques such as frictional welding.

Other welding techniques for minimizing oxide formation, porosity, and other structural flaws are well know to those skilled in the art and can be use for welding KANTHAL® to Nichrome. One such technique is that of inert gas shielded arc welding.

Terminal Configuration

Referring again to FIGS. 1A and 1B, the heating element includes two threaded power terminal ends 114 for connection to a source of electric current. The two terminals 114 can be incorporated into a single end unit 120 that acts as a cover plate so that the heating element assembly 100 can be inserted into a furnace from outside the process chamber in cartridge fashion. Nickel portion 112 of heating element wires are electrically insulated by insulator 124. However, due to the design of the heating element assembly that concentrates heat within the aluminum ceramic sleeve 102, heating does not reach the terminal end thereby providing wider range for choice of insulator material. Minimizing heating in this terminal area prevents damage to the terminal and enhances its ability to provide and maintain stable electrical connection. It also results in added electrical efficiency for the furnace operation.

The preferred embodiment includes a short transverse rod (torque eliminator) 126 on the threaded terminal end 114 which conformably engages a recess provided in insulator 124. The transverse rod 126 prevents inadvertent torque, during terminal tightening, from causing damage to the heating element wire. The same insulator 124 can serve both terminals, incorporating them in a single unit 120 which facilitates element installation or removal. A preferred material insulator material 124 is TEFLON®. The terminals themselves are secured to the nickel portion 112 of heating element wire 104 by welding or brazing at a terminal weld or braze joint 128.

Example Application of Heating Elements

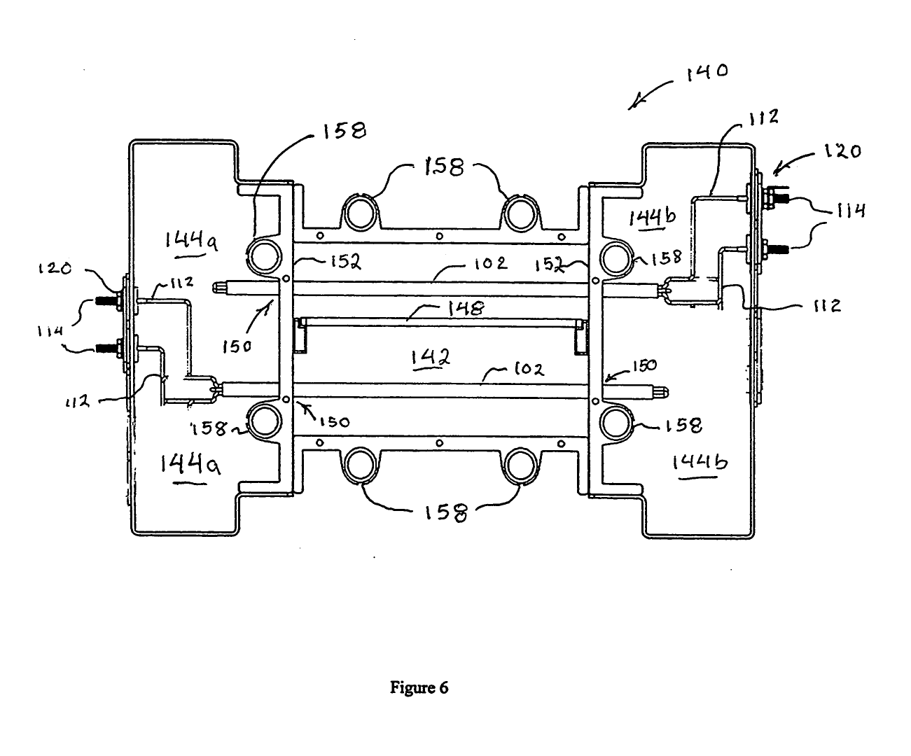

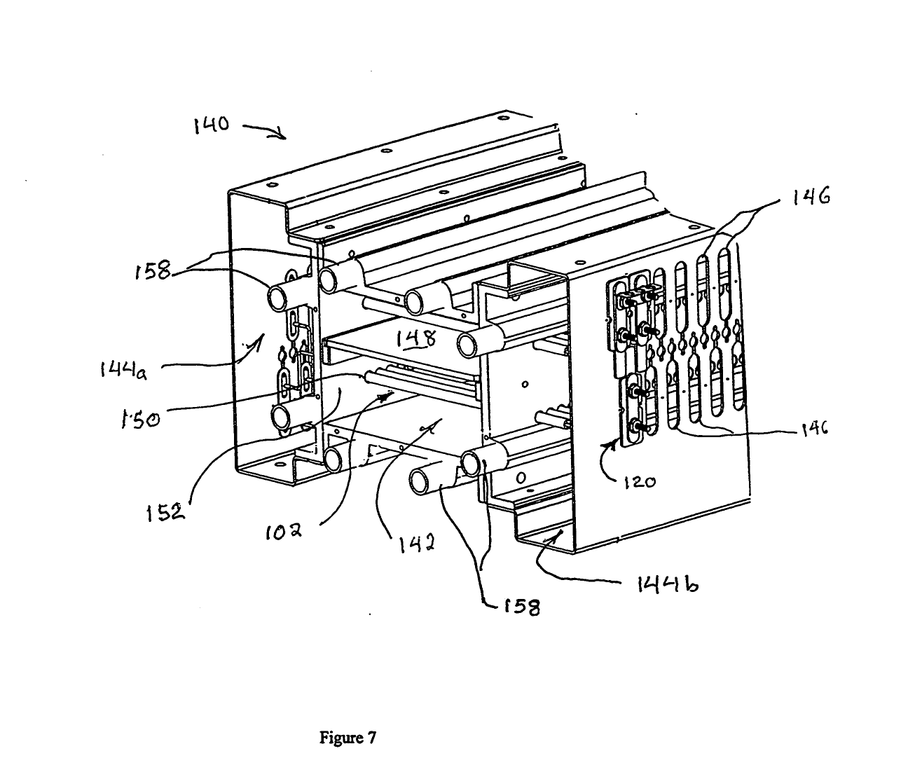

Referring to FIG. 6 and 7, the heating elements of FIG. 1A are shown in a preferred embodiment in furnace for high temperature atmospheric pressure chemical vapor deposition (APCVD). The heating elements are also suitable for other types of furnaces for semiconductor processing. The furnace 140 defines a process chamber 142 also referred to as a tunnel or muffle. Process chamber 142 includes an inlet end and outlet end. As is well understood by those skilled in the art, a conventional structure for providing a gas curtain (not shown for the sake of clarity) is disposed at the inlet and outlet ends of the process chamber. A separate plenum 144a, 144b is provided on opposing sides of the process chamber 142 as shown. Plenum 144a and plenum 144b are filled with an inert gas such as argon. It will be appreciated that each end of ceramic sleeve 102 is disposed in the inert gas atmosphere off plenum 144a, 144b on either side of the process chamber 142. This has the advantage of further preventing entry of air into the interior of ceramic sleeve 102 and imposes a further restriction on oxidation of the KANTHAL®, or other like Fe Cr Al wire enclosed within ceramic sleeve 102.

Each plenum is provided with a series of access ports 146 on an external sidewall for external insertion of the heating elements in modular, cartridge-like fashion into the process chamber. Each external access port 146 is provided for receiving a terminal end 120 of the heating element. Each terminal end 120 covers a respective access port 146 to maintain a closure for the inert gas in each plenum. Each heating element is fastened to the outside of the plenum in a well-known manner.

In the example, a plurality of heating elements 102 are arranged in two planar arrays disposed above and beneath a substrate 148 in process chamber 142. Heating elements 102 are inserted into the process chamber through a series of respective access ports 150 defined in sidewalls 152 of the process chamber.

In the example of FIGS. 6 and 7, in contrast to a conventional furnace, the internal aluminum walls defining the process chamber are highly polished to an “optical mirror” finish, characterized by very low emissivity (i.e. high reflectivity). At process temperatures mentioned, above 1200-1350° C., the dominant mode of heat transfer is radiation, which is then effectively contained by the mirror surfaces. Although reflectivity decreases as temperature rises, to counteract this effect, the sidewalls 152 as well as the top wall 154 and bottom wall 156 that define the process chamber are provided with built-in active cooling channels 158. Active cooling of the polished aluminum surface can be achieved by forced circulation of coolant (e.g. water) through channels 158 to remove non-reflected heat. This design has been found to effectively prevent a decrease in reflectivity as temperature increases, and further prevents damage to the polished surface.

Since aluminum melts at 660° C., it is not an obvious choice for the interior of a process chamber designed for process temperatures in the vicinity of 1200° C. and above. In a conventional CVD processing system, there is an aversion to the use of aluminum as a material for the walls in a high temperature process chamber due to its low melting point (660 degrees C.) and, “due to physical sputtering of ions which attack chamber surfaces, such as aluminum walls, resulting in metal contamination of the substrate.” See U.S. Pat. No. 6,444,037 (emphasis added). However, the active cooling channels of the polished aluminum process chamber overcome this presumed limitation and prove the opposite is true by removing as much heat as possible from the aluminum surface so that it remains relatively cool and thus inert with respect to the processing. Further, by polishing the aluminum to provide a mirror like surface, heat energy is reflected back to the heating elements and to the workpiece, minimizing heat loss that would otherwise force the heating elements to a higher temperature, and minimizing ΔT between the heating elements and the workpiece.

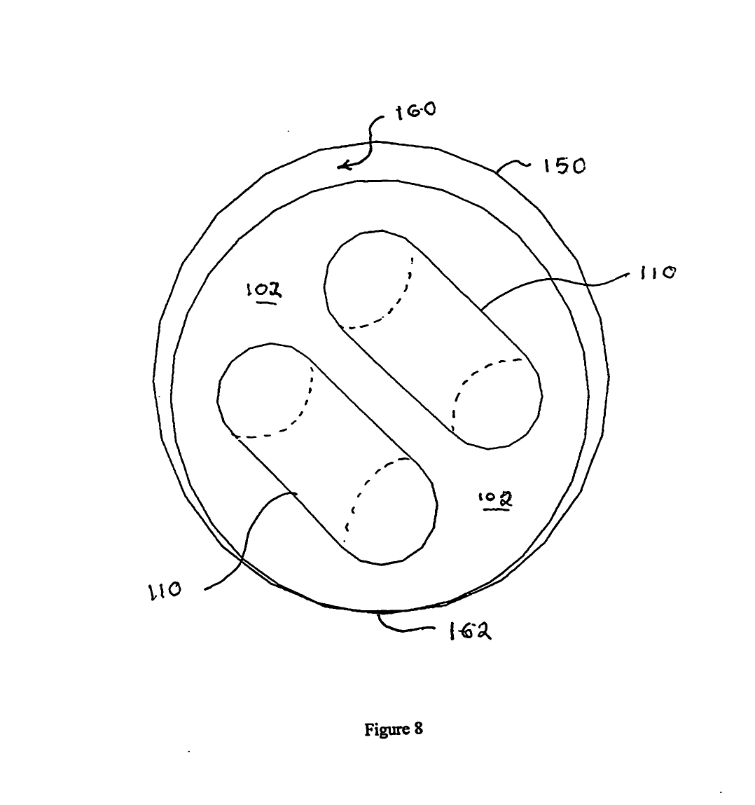

Referring to FIG. 8, the ceramic sleeve 102 of each heating element 100 is inserted all the way through access ports 150 defined in both sidewalls 152 of process chamber 142 such that the distal end of the ceramic sleeve 102 extends entirely through the process chamber and into a plenum 144a or 144b on either side of the process chamber 142. FIG. 8 shows an end view of the ceramic sleeve 102 (opposite the terminal end 120). As previously explained, nichrome portion 110 of the heating element wire substantially blocks ingress of air into the interior of the ceramic sleeve 102. Process chamber access port 150 defines a clearance space 160 provided to minimize heat transfer from the ceramic sleeve 102 into the aluminum surface of access port 150. Although the ceramic sleeve, operating at about 1200° C. or above, is in actual contact with the aluminum at the bottom surface of process chamber access port 150, the contact point 162 is a minimized tangential point of contact. The contact is virtually 2 point (substantially zero cross-sectional area) and thereby prevents heat loss from the ceramic sleeve 102, that would make the ceramic sleeve cool and the aluminum hot in spite of such a large temperature difference.

Referring again to FIGS. 6 and 7, the furnace 140 is intended for horizontal processing; that is, a semiconductor substrate 148 or quartz carrier or the like, slides into an entrance end of the process chamber 142, for thermal processing and comes out the other end. A rail 164 is thus provided on each sidewall 152 of the process chamber 142 for slidable entry of the substrate. In one embodiment rail 164 is made out of aluminum. It is fastened to the polished actively cooled interior surface of the sidewalls 152 of the process chamber with small screws. These small screws support the rail 164 but also pull it close to the cooled aluminum process chamber walls 152. This close contact with the cooled walls thus cools the rail as well.

As is well understood by one skilled in the art, other materials can be used for rails. Examples include refractory metals, such as high temperature molybdenum, provided the process atmosphere is not oxidizing or otherwise corrosive. The surface of refractory metals such as molybdenum can be treated with materials such as silicon or carbon to increase its resistance to chemical attack.

Example of Operation

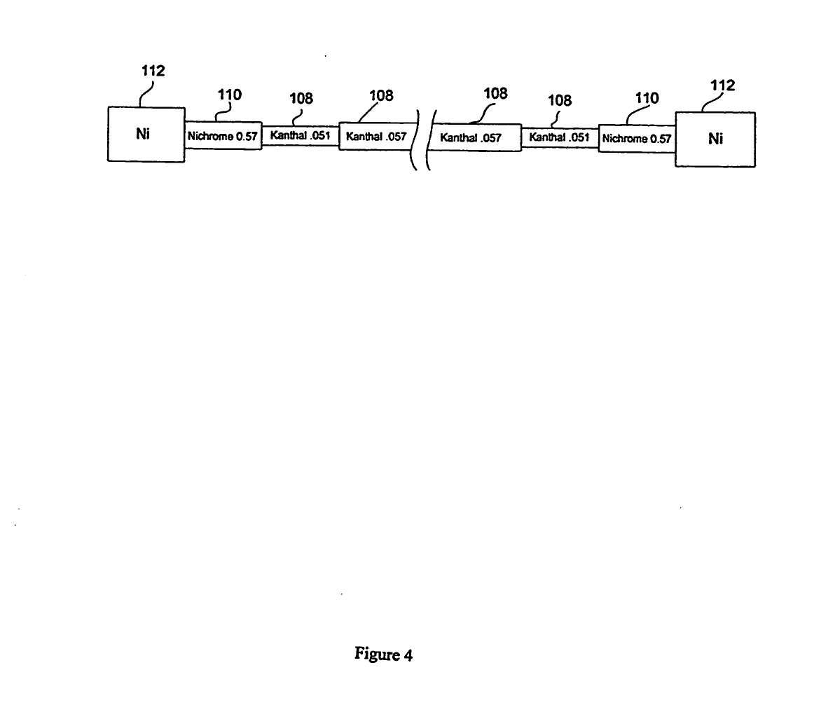

The heating elements in FIGS. 1A and 1B were employed in two parallel planar arrays in a furnace having an aluminum, water cooled tunnel or muffle as shown in FIGS. 6 and 7. Each array consisted of 20 aluminum ceramic (Al₂O₃) heating elements. The heating element wire was a nickel, nichrome, KANTHAL® composite wire. The heating portion of the wire within the ceramic sleeve consisted of 0.051 inch diameter KANTHAL® wire on the end portions with 0.057 kanthal in a central portion double backed in linear fashion in four through-holes defined in a one quarter inch (0.250) diameter aluminum ceramic sleeve. A nichrome portion was welded to the 0.051 diameter KANTHAL® wire and disposed in the entrances of through holes of in the ceramic sleeve as explained with reference to FIG. 4. The aluminum ceramic sleeve was inserted into holes in the process chamber which are slightly larger (0.256-0.265) in diameter. The heating elements were placed about three eighths inch (0.375) apart. A workpiece (product) comprising a processed silicon wafer was positioned on the substrate or product support structure provided between the planar arrays of heating elements. The substrate rested on aluminum rails attached to water-cooled sidewalls of the muffle as shown in FIGS. 6 and 7. The power applied to the terminals of the heating elements was 220 Volts AC, single phase. Thermocouples measured temperature of the rails and external surface of the muffle. A standard optical pyrometer measured the product, product support and ceramic sleeve temperature. A probe at each end of the ceramic sleeve was used to measure resistance of the wire and current through the wire to produce temperature. The following results were achieved.

| | |
|---|---|
| Product temperature | 1350° C. |
| Product support temperature | 1350° C. |
| Water-cooled tunnel (muffle) external temperature | 40° C. |
| Rail temperature | 40° C. |
| Heating element wire temperature | 1400° C. |
| Ceramic sleeve temperature | 1400° C. |

While the invention has been described in connection with what are presently considered to be the most practical and preferred embodiments, it is to be understood that the invention is not limited to the disclosed embodiments and alternatives as set forth above, but on the contrary is intended to cover various modifications and equivalent arrangements included within the scope of the forthcoming claims. For example, other high temperature metals, such as tungsten, molybdenum, or the like can be encased in a ceramic sleeve enabling thermal expansion of the metals and providing mechanical support to enable such metals to function as high temperature heating elements. Therefore, persons of ordinary skill in this field are to understand that all such equivalent arrangements and modifications are to be included within the scope of the following claims.

1. A heating element for preventing contamination of a workpiece in a furnace including aluminum walls defining a reflective process chamber comprising:
a first resistive wire having a first diameter comprising an alloy of aluminum chromium and iron encased in a supporting aluminum ceramic sleeve located within the process chamber and supported at a terminal end in a wall of the furnace;
a nichrome wire welded to the first resistive wire having a second diameter larger than the first diameter for providing a transition zone to reduce heating from the first wire;
a nickel wire welded to the nichrome for further reducing heat to the supporting terminal.

2. In a furnace including a process chamber for processing a semiconductor substrate, and first and second plenums on either side of the process chamber; the improvement comprising:
a high temperature heating element adapted for exterior insertion through the first and/or second plenum into the process chamber comprising an aluminum ceramic sleeve having a terminal end and a distal end, two or more bores defined in the ceramic sleeve, each bore providing chemically inert, substantially flush engagement with a graded ohmic composite wire for concentrating heat up to 1400 degrees C. within the ceramic sleeve.

3. An apparatus as in claim 2, wherein the graded ohmic composite wire further comprises;
a primary heating portion contained within the ceramic sleeve characterized by high resistance and high heat;
a second section fusion bonded to the primary heating portion, provided at the terminal and distal ends of the ceramic sleeve, characterized by lower resistance, higher conductivity, and much lower heat with respect to the primary heating portion, and
a terminal portion for connection to a source of electric current, fusion bonded to the second section, the terminal portion characterized by lower resistance, higher conductivity, and lower heat with respect to the second section,
such that heating of the substrate is effected primarily by the first high resistance portion within the ceramic sleeve.

4. An apparatus as in claim 2, wherein the primary heating portion comprises an Fe Cr Al resistance heating alloy wire characterized by high resistance and high heat, the second portion comprises nichrome, and the terminal portion comprises nickel for attachment to a source of electric current.
